(19) United States
(12) Patent Application Publication
(10) Pub. No.: US 2019/0216073 A1
(43) Pub. Date: Jul. 18, 2019

(54) QUICK-RELEASE TRACK MOUNT FOR RAIL-BASED FISHING POLE HOLDER

(71) Applicant: GENE J. TORNOW, CENTERLINE, MI (US)

(72) Inventor: GENE J. TORNOW, CENTERLINE, MI (US)

(21) Appl. No.: 15/870,789

(22) Filed: Jan. 12, 2018

(51) Int. Cl. A01K 97/10

(52) U.S. Cl. CPC A01K 97/10

(57) ABSTRACT

A quick-release mount intended for use with a rail-type fishing-rod-holder system. The quick-release mount has a length, width, overall height, and retention layer height. The rail of the rail-type fishing-rod-holder system has a length, width, height, open end, and lengthwise rail lips forming lengthwise rail grooves. The quick-release mount width fits between the lengthwise rail lips. When rotated, the quick-release mount is locked in place.

### FIELD OF INVENTION

This invention relates to the class, Fishing, trapping, and vermin destroying, and the sub-classes related to rods. Specifically, this invention relates to holders, supports, and steadying devices for fishing poles

### BACKGROUND OF INVENTION

The present invention refines and builds upon the current state-of-the-art for fishing pole holders. Fishing boats, generally, and charter fishing boats, specifically, have fishing pole holders arranged along the gunwale, the upper, flat edge of the side of the boat. One of the most popular arrangements is to have a rail mounted on the gunwale, into which multiple fishing rod holders are fitted. The fishing-rod holders interface with rail system through a mount. The mount is generally secured to the fishing rod holder with screws. The mount and fishing rod holder are usually left connected, as there is no motivation to repetitively screw and un-screw a fishing-pole holder from the mount.

Fishing-rod holder and mount assemblies (“assemblies”) can be secured into position by sliding them onto the rail system at the end of the rail system. Currently, assemblies can only be added at the end of the rail system. In this configuration, the assemblies are added in a first-on, last-off fashion.

Since assemblies can only be added at the end of the rail, current fishing rod holder rails systems have an inherent problem. When there is a need to remove or add an assembly from- or to-the center of the rail, all the assemblies between the one of interest and the end of the rail must be removed. With only a single way to add and remove fishing rod holder assemblies, set-up and break-down time can be significant.

It is not unusual for a boat owner to invest ten thousand dollars or more invested in a pole-holder system. Due to the value of the gear, it must be removed from the boat, and secured, every time the boat is unattended. This is a labor-intensive problem in search of a solution. What the market needs is a quick-release mount for rail-based fishing-pole holders. Such a quick-release mount should allow assemblies to be secured quickly. It should allow for assemblies to be removed quickly. Lastly, it should allow assemblies to be added and removed without reference to the proximity of the individual fishing-rod holder to the end of the rail system.

### SUMMARY OF THE INVENTION

This summary is intended to disclose the present invention, a quick-release mount, which is intended for use with a rail-type fishing-rod-holder system. The embodiments and descriptions are used to illustrate the invention and its utility, and are not intended to limit the invention or its use.

The quick-release mount has a width, a length, and a height. The quick-release mount has a top surface, bottom surface, two retention surfaces and two compound lateral surfaces. The top surface, bottom surface, and retention surfaces all have a surface area. The surface area of the bottom surface is equal to the surface area of the top surface plus the surface area of the two retention surfaces. The bottom surface is disposed opposite from the top surface and the two retention surfaces. The distance between the top surface and the bottom surface is the height of the quick-release mount. The two retention surfaces are disposed between the top surface and bottom surface.

The top surface is defined by two continuous edges. Each of the two continuous edges are made up of two straight edge segments separated by an arc segment. The two continuous edges meet at two right angles. The top surface has plurality of through-holes with which to attach a fishing-rod holder. The through-holes can either be threaded to accept a threaded fastener, or the through-holes can be unthreaded. For an unthreaded through-hole, placing a screw-head recess in the bottom surface is preferable.

Each retention surface is defined by a plurality of edges. Each retention surface has at least two straight edges and two curved edges. In the preferred embodiment, the retention surfaces have three straight edges and two curved edges. The two curved edges of each retention surface intersect tangentially.

The quick-release mount has two compound lateral surfaces. Each compound lateral surface is comprised of an upper lateral surface, a lower lateral surface, and a common lateral surface. The common lateral surface of one compound lateral surface ends orthogonally at the upper and lower lateral surface of the other compound lateral surface.

Each retention surface lies between the upper lateral surface and the lower lateral surface of its respective compound lateral surface. The retention surface is orthogonal to both the upper lateral surface and the lower lateral surface.

The quick-release mount is used in conjunction with a rail-type fishing-pole holder system. Typically, the rail or track is fastened to the gunwale of a fishing boat. The rail has a length, width, and height. The rail has two edges and two ends. The rail has two rail lips running the lengthwise along each edge of the rail. The rail lips make a recessed groove running lengthwise along the edge of the rail.

The quick-release mount can be oriented so that its width orthogonally transverses the distance between the rail lips. When properly oriented like this, the quick-release mount fits between the narrowest dimension between the rail lips. The bottom surface of the quick-release mount rests on the bottom surface of the rail. In this position, the quick-release mount will be free to rotate in one direction, but not the other. By rotating the quick-release mount until it comes to a stop, one can lock the quick-release mount into place. The quick-release mount will resist sliding towards one end of the rail, but will rotate and release when a translational force is applied on the quick-release mount towards the other rail end. By making a mirrored pair of quick-release mounts, locking in either direction is possible.

By connecting a fishing-rod holder to the quick-release mount, fishing-rod holders can be added quickly to a rail-type system mounted on a fishing boat gunwale. The quick-release mount will allow fishing-rod holders to be added at any location along the length of a rail.

The quick-release mount has unitary construction, meaning that it is a single, solid piece of material. It is fabricated from a strong structural material. Such a material should be corrosion resistant, temperature stable, and environmentally non-reactive. Metals, such as stainless steel, aluminum, magnesium, are appropriate without any corrosion coatings. Most steel alloys are appropriate, provided they are treated with a corrosion coating such as trivalent chromium or galvanized zinc. There are numerous suitable corrosion coatings for steel that could be used for the present invention. Polymers can also be used to fabricate the present invention, provided that the polymer is strong, dimensionally stable, temperature stable, and environmentally non-reactive. Plastics such as acrylonitrile butadiene styrene (“ABS”), polycarbonate, nylon 6, acrylic, polyoxymethylene (“POM”), and glass-reinforced polypropylene are appropriate thermoplastics.

### BRIEF DESCRIPTION OF THE DRAWINGS

The present invention is illustrated with 8 drawings on 6 sheets.

FIG. 1 is a perspective view of the present invention, a quick-release mount.

FIG. 2 is a top view of the present invention.

FIG. 3 is a lateral view of the present invention.

FIG. 4 is an alternative lateral view of the present invention.

FIG. 5 is a bottom view of the present invention.

FIG. 6 is a perspective view of a rail from a fishing-pole rail-mounting system.

FIG. 7 is a perspective view of the present invention along with the rail from the fishing-pole rail-mounting system, showing the orientation of the present invention as it is inserted into the rail.

FIG. 8 shows a perspective view of an alternative embodiment of the present invention, a mirror image of the present invention shown in FIG. 1.

### DETAILED DESCRIPTION OF THE DRAWINGS

The following descriptions are not meant to limit the invention, but rather to add to the summary of invention, and illustrate the present invention, a quick-release mount intended for use with a rail-mounted fishing-pole holder system. The present invention is illustrated with a variety of drawings showing various possible embodiments.

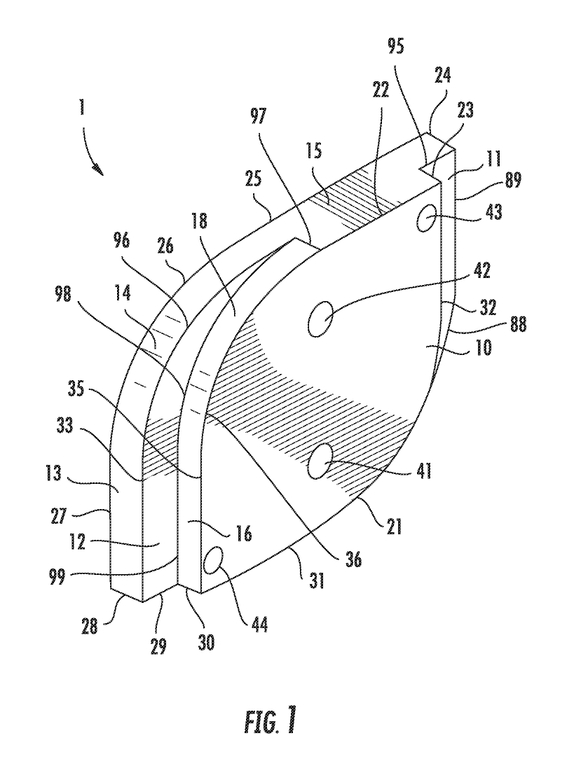

FIG. 1 shows a perspective view of a quick-release mount 1. The present invention 1, a quick-release mount 1 has a top surface 10 defined by two continuous edges 35, 36, 22 and 32, 21, 31. Four of the edge segments are straight 35, 22, 32, 31 and two are arcs 36, 21. On each continuous edge 35, 36, 22 and 32, 21, 31, two straight segments 35, 22 and 32, 31 are separated by an arc segment 36, 21, respectively. The two continuous edges 35, 36, 22 and 32, 21, 31 meet at two corners 31, 35 and 32, 22. Segment 31 is orthogonal to segment 35; and segment 32 is orthogonal to segment 22. In other words, the two continuous edges 35, 36, 22 and 32, 21, 31 meet at two right angles. The top surface has four through-holes 44, 41, 42, 43.

The present invention 1 has two retention surfaces 12, 11. The retention surface 12 is defined by edges 29, 99, 98, 96, 33. The retention surface 12 has three straight edges 29, 99, 33 and two curved edges 98, 96. The two curved edges 98, 96 intersect tangentially. Only two of the edges 88 89 of the other retention surface 11 are visible in FIG. 1.

The present invention 1 has two identical compound lateral surfaces, one of which is visible 18, 16, 15, 14, 13 in FIG. 1. The compound lateral surface 18, 16, 15, 14, 13 is composed of an upper lateral surface 18, 16; a lower lateral surface 13, 14, and a common lateral surface, 15. The upper lateral surface 18, 16 is defined by edges 35, 36, 97, 98, 99, 30. The lower lateral surface 13, 14 is defined by edges 28, 33, 96, 25, 26, 27. The lower lateral surface 13, 14 transitions into the common lateral surface 15 at the termination of edge 97. The common lateral surface 15 is defined by edges 97, 25, 24, 95, 23, 22.

The retention surface 12 lies between the upper lateral surface 18, 16 and the lower lateral surface 13, 14. The retention surface 12 is orthogonal to both the upper lateral surface 18, 16 and the lower lateral surface 13, 14.

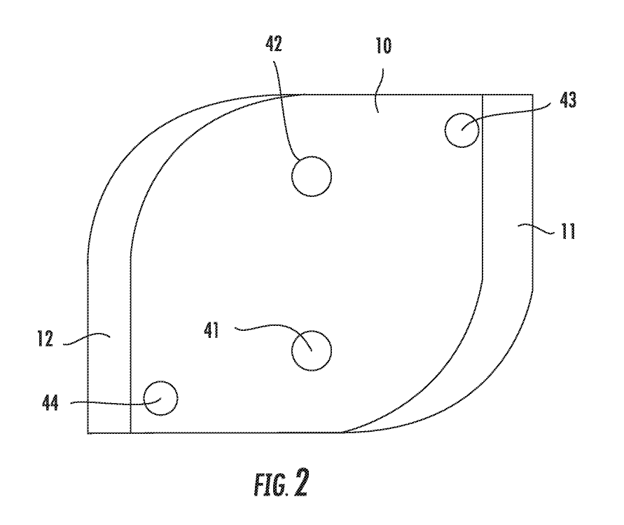

FIG. 2 is a top view of the quick-release mount. The four through-holes 44, 41, 42, 43 for threaded fasteners are shown. Additionally, the relative size and orientation of the top surface 10 and the two retention surfaces 11, 12 are shown.

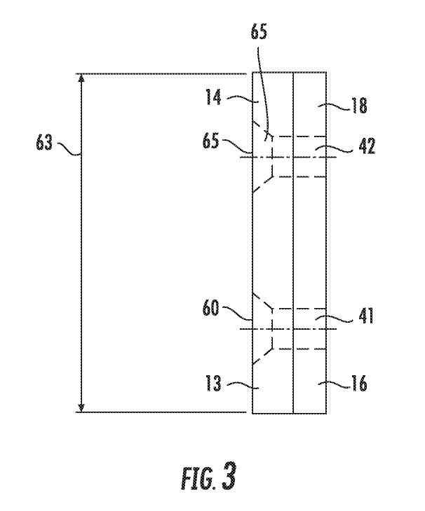

FIG. 3 is a lateral view of the present invention, showing the width 63 dimension. The lower lateral surface 13, 14 and the upper lateral surface 18, 16 in this view. Additionally, two of the threaded fastener through-holes 41, 42 are shown. These two through-holes 41, 42 have a recessed screw feature 65, 60. FIG. 4 is another lateral view of the present invention 1, showing the length 64 dimension and the thickness 68, 67 dimensions. The through-holes 41, 42, 43, 44 are visible in this view, as are the screw head recesses 65, 60 of two of the through holes 41, 42.

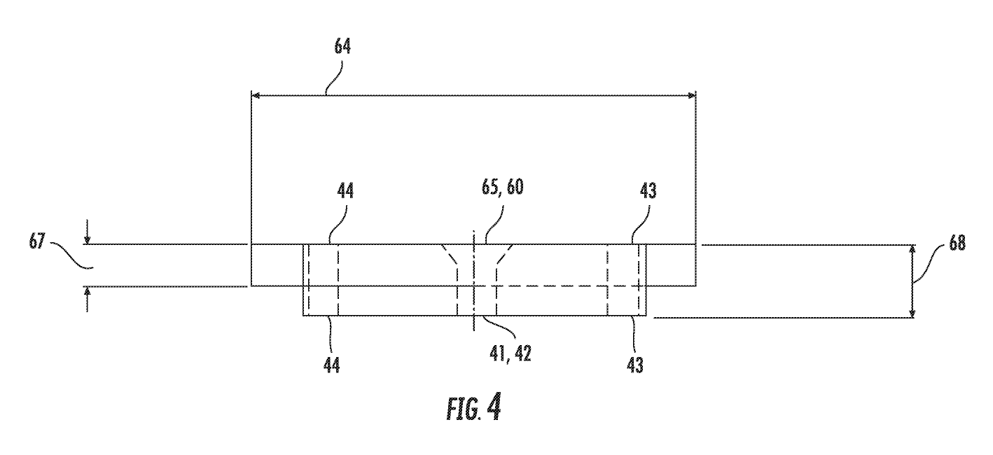

FIG. 5 is a rear perspective of the present invention 1. The present invention 1, a quick-release mount 1 has a bottom surface 70, defined by two continuous edges 25, 26, 27 and 71, 72, 73. Four of the edge segments are straight 25, 27, 71, 73 and two are arcs 26, 72. The two continuous edges 25, 26, 27 and 71, 72, 73 meet at two corners 71, 25 and 27, 73, meaning they intersect orthogonally. The bottom surface has four through-holes 44, 41, 42, 43. Two of the through holes 41, 42 have screw-head recesses 65, 60. The screw-head recesses 65, 60 allow a recess for a mounting-screw head. Two of the through-holes, 43, 44, are threaded. The other two through-holes 41, 42 are not threaded, although they have screw-head recesses 65, 60. A variety of surfaces 15, 18, 14 and edges 23, 24 are also visible in this view.

The bottom surface 70, top surface 10, and retention surfaces 12, 11 all have areas enclosed by continuous edges. The bottom surface 70 area is enclosed by two continuous edges 25, 26, 27 and 71, 72, 73. The top surface 10 area is enclosed by two continuous edges 35, 36, 22 and 32, 21, 31. The retention surface 12 area is enclosed by five edges 29, 99, 98, 96, 33. The bottom surface 70 area is equal to the top surface 10 area plus the retention surfaces 12, 11 area. The overall thickness 68 is measured from the bottom surface 70 to the top surface 10. The retention layer thickness 67 is measured from the bottom surface 70 to the retention surface 12, 11.

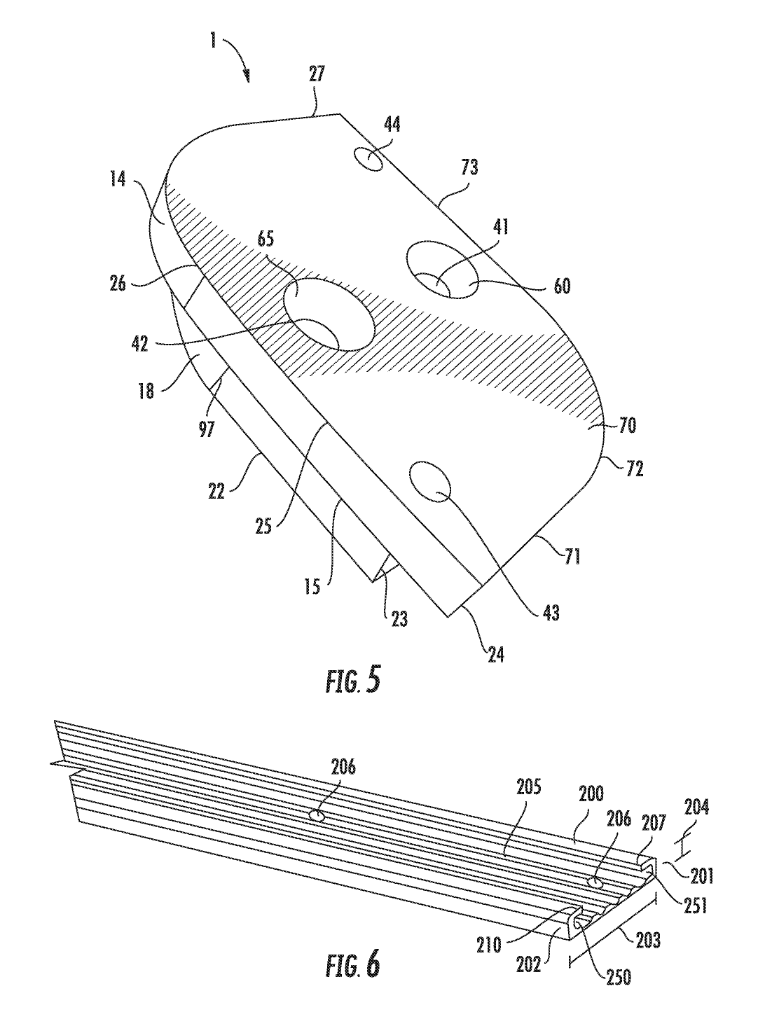

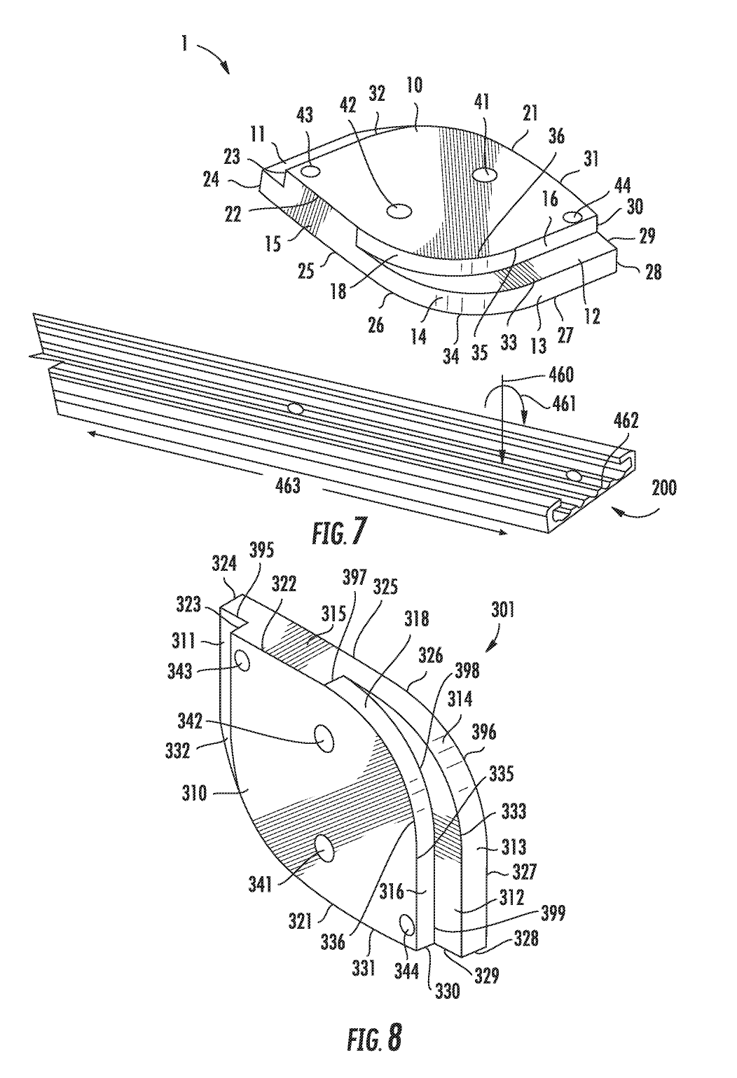

FIG. 6 shows a rail (also known as a track) 200 for a fishing-pole rail-mounting system. The rail 200 has a length (shown in FIG. 7 as 463), width 203 and a height 204. The rail 200 has two lengthwise rail lips 207, 210 that define two respective lengthwise rail grooves 251, 250. The rail 200 has two lateral exterior surfaces 202, 201 and a bottom surface 205. The rail 200 is mounted to a boat gunwale with a plurality of threaded fasteners, threaded through a plurality of screw-holes 206.

FIG. 7 shows the present invention 1, a quick-release mount 1 in relationship with the rail 200. The quick-release mount 1 can be placed anywhere along the length 463 of the rail 200. The quick-release mount 1 is aligned 460 with respect to the rail 200 so that the width 63 of the quick-release mount 1 (shown in FIG. 3) fits between the two rail lips 207, 210 (shown in FIG. 6). Once the bottom surface 70 (shown in FIG. 5) of the quick-release mount 1 is in contact with the bottom surface 205 (shown in FIG. 6) of the rail 200, the quick-release mount 1 is rotated 461, locking the quick-release mount 1 into place. The retention surfaces 12, 11 are held in place by the rail lips 210, 207. The top surface 10 fits between the rail lips 210, 207. Surface 16 fits securely against the rail lip 210. Surface 13 fits securely against the rail groove 250.

Once locked into place, the quick-release mount 1 cannot slide towards the open end 462 of the rail 200. Since fishing lines are typically cast over the side of the boat and then pulled behind the boat, the quick-release mount 1 would be locked in place if the rail 200 was oriented on a gunwale so that the open end 462 was parallel with the stern of the boat.

A fishing-pole holder (not shown) can be secured to the quick-release mount 1 using threaded fasteners. Using the unthreaded through-holes 42, 41, the head of the threaded fastener would fit into the screw-head recesses 65, 60 in the bottom surface 70, with the threaded fastener capturing the fishing-pole holder to the top surface 10. Using the threaded through-holes 43, 44, the threaded fastener would enter the hole from the top surface 10 and would secure the fishing-pole holder (not shown) to the top surface 10. The quick-release mount 1 can be placed anywhere along the length 463 of the rail 200. In this way, the quick-release mount 1 allows fishing-rod holders to be placed anywhere along the length 463 of the rail 200.

FIG. 8 shows a perspective view of a mirror-imaged quick-release mount 301, from that shown in FIG. 1. The present invention 301, a quick-release mount 301 has a top surface 310 defined by two continuous edges 335, 336, 322 and 332, 321, 331. Four of the edge segments are straight 335, 322, 332, 331 and two are arcs 336, 321. The two continuous edges 335, 336, 322 and 332, 321, 331 meet at two corners 331, 335 and 332, 322, meaning they intersect orthogonally. The top surface 310 has four through-holes 344, 341, 342, 343. The present invention 301 has two retention surfaces 312, 311. The retention surface 312 is defined by edges 329, 399, 398, 396, 333. The retention surface 312 has three straight edges 329, 399, 333 and two curved edges 398, 396. The two curved edges 398, 396 meet.

The present invention 301 has a compound lateral surface 318, 316, 315, 314, 313 that is visible in FIG. 8, and a mirrored compound lateral surface (not visible). The compound lateral surface 318, 316, 315, 314, 313 is composed of an upper lateral surface 318, 316; a lower lateral surface 313, 314, and a common lateral surface 315. The upper lateral surface 318, 316 is defined by edges 335, 336, 397, 398, 399, 330. The lower lateral surface 313, 314 is defined by edges 328, 333, 396, 325, 326, 327. The lower lateral surface 313, 314 transitions into the common lateral surface 315 at the termination of edge 397. The common lateral surface 315 is defined by edges 397, 325, 324, 395, 323, 322.

The present invention 1, 301 has unitary construction, meaning that it is a single, solid piece of material. The present invention 1, 301 is fabricated from a strong structural material. Such a material should be corrosion resistant, temperature stable, and environmentally non-reactive. Metals, such as stainless steel, aluminum, magnesium, are appropriate without any corrosion coatings. Most steel alloys are appropriate, provided they are treated with a corrosion coating such as trivalent chromium or galvanized zinc. There are numerous suitable corrosion coatings for steel that could be used for the present invention. Polymers can also be used to fabricate the present invention, provided that the polymer is strong, dimensionally stable, temperature stable, and environmentally non-reactive. Plastics such as acrylonitrile butadiene styrene (“ABS”), polycarbonate, nylon 6, acrylic, polyoxymethylene (“POM”), and glass-reinforced polypropylene are appropriate thermoplastics.

I claim:

1. A quick-release mount device comprising
a top surface, having an area enclosed by continuous edges;
a bottom surface, having an area enclosed by continuous edges;
two retention surfaces, each having an area enclosed by continuous edges;
and two compound lateral surfaces;
wherein the top surface is defined by two continuous edges;
wherein each compound lateral surface is composed an upper lateral surface, a lower lateral surface, and a common lateral surface; and
wherein each retention surface lies between the upper lateral surface and lower lateral surface of a corresponding compound lateral surface.

2. The quick-release mount device of claim 1, wherein the area of the bottom surface is equal to the area of the top surface plus the area of the two retention surfaces.

3. The quick-release mount device of claim 1, wherein each continuous edge of the top surface is comprised of two straight segments separated by an arc segment.

4. The quick-release mount device of claim 3, wherein the continuous edges of the top surface meet at two right angles.

5. The quick-release mount device of claim 1, wherein each retention surface is orthogonal to both its respective upper and lower lateral surfaces.

6. The quick-release mount device of claim 5, wherein the retention surface is defined by three straight edges and two curved edges.

7. The quick-release mount device of claim 6, wherein the two curved edges of each retention surface intersect tangentially.

8. The quick-release mount device of claim 1, wherein the device has unitary construction, meaning that it is a single, solid piece of material.

9. The quick-release mount device of claim 8, wherein the device is fabricated from at least one of stainless steel, aluminum, and magnesium.

10. The quick-release mount device of claim 8, wherein the device is fabricated from steel that has been treated with a corrosion coating, said corrosion coating being at least one of trivalent chromium and galvanized zinc.

11. The quick-release mount device of claim 8, wherein the device is fabricated from at least one of acrylonitrile butadiene styrene (“ABS”), polycarbonate, nylon 6, acrylic, polyoxymethylene (“POM”), and glass-reinforced polypropylene.

12. A quick-release mount system for fishing-rod holders comprised of
one quick-release mount device; and
a rail;
the quick-release mount device is comprised of
a length, width, and overall height;
a top surface, having an area enclosed by continuous edges;
a bottom surface, having an area enclosed by continuous edges;
two retention surfaces, each having an area enclosed by continuous edges;
and two compound lateral surfaces;
the top surface is defined by two continuous edges;
each compound lateral surface is composed an upper lateral surface, a lower lateral surface, and a common lateral surface; and
each retention surface lies between the upper lateral surface and lower lateral surface of a corresponding compound lateral surface; and
the rail is comprised
a rail width, a rail height, and a rail length;
at least one rail end; and
two lengthwise rail lips creating two lengthwise rail grooves;
wherein, when properly oriented, the quick-release mount device width fits between the two rail lips of the rail.

13. The quick-release mount system for fishing-rod holders of claim 12 wherein, when rotated, the retention surfaces of the quick-release mount fit into the rail grooves, locking the quick-release mount in place by preventing translational motion of the quick-release mount towards at least one end of the rail.

14. The quick-release mount system for fishing-rod holders of claim 13 further comprising a second quick-release mount device, which is a mirror image of the first quick-release mount device, wherein, when properly oriented, the second quick-release mount device width fits between the two rail lips of the rail.

15. The quick-release mount system for fishing-rod holders of claim 14, when rotated, the retention surfaces of the second quick-release mount fit into the rail grooves, locking the quick-release mount in place by preventing translational motion of the quick-release mount towards at least one end of the rail.
